(19) United States
(12) Patent Application Publication
(10) Pub. No.: US 2003/0043151 A1
(43) Pub. Date: Mar. 6, 2003

(54) Method for lossy optimization and storage of font

(75) Inventors: Jae Young Choi, Seoul (KR); Young Pyo Lee, Seoul (KR); Geun Ho Chung, Seoul (KR)

Correspondence Address: BACON & THOMAS, PLLC, 625 SLATERS LANE, FOURTH FLOOR, ALEXANDRIA, VA, 22314

(73) Assignee: Jae Young Choi, Seoul (KR)

(21) Appl. No.: 09/969,725

(22) Filed: Oct. 4, 2001

(30) Foreign Application Priority Data
Jul. 12, 2001 (KR) 2001-42171

(51) Int. Cl. G06T 11/00

(52) U.S. Cl. 345/467

(57) ABSTRACT

A method for lossy optimization and storage of font is provided. The method includes the steps of (a) dividing the font into unit elements on a contour basis to generate a plurality of contours; (b) performing a similarity comparison between the contours to create a similarity comparison list; (c) unifying two or more contours, if the two or more contours are determined to be similar to each other in the similar comparison list; (d) selecting a representative contour to be displayed on a screen among the contours within the similarity comparison list; (e) deleting one or more glyph tables no longer required in the similarity comparison list; and (f) generating a new glyph table by using the glyph tables not deleted at step (e).

### FIELD OF THE INVENTION

The present invention relates to a method for lossy optimization and storage of “Hangul” or Korean font; and, more particularly, to a method for lossy optimization and storage of Korean font for compressively storing a font through a unification process on duplicated or similar information without scarifying quality of the original font in such a lower resolution output device, e.g., cathode-ray tube (CRT) or liquid crystal display (LCD), by using similarity information between elements of characters in a Korean digital font used in a digital device, e.g., a cellular phone, an IMT-2000 terminal, a high definition television (HDTV), a personal digital assistant (PDA), a electronic book or the like.

### BACKGROUND OF THE INVENTION

Generally, there are two types of well-known font representation method: a bitmap font and a contour font in accordance with a representation type in order to represent characters in a digital device. In the bitmap font, each character is viewed as a figure or an image so that it may be represented as a point array with a predetermined size. Specifically, the point array with a predetermined size is initialized with 0, a plurality of points on the point array are changed to 1 according to the figure of a character to be represented and the changed result is stored as the point array for the character. Accordingly, if the font size increases in the bitmap font, the font quality may be degraded because of a so-called step phenomenon and a still larger storage space is required to store the bitmap font with various font sizes.

Meanwhile, in the contour font, contours of each character are represented by using a geometrical method, and figures of the character may generally be represented by using mathematical elements such as lines, curves, circles. Although the contour font is manufactured with a rather complex process, the contour font has more adaptability and still better output quality compared to the bitmap font. Among a plurality of contour fonts prevailed at present, a true type font has been used in an operating system such as Windows 98, Windows NT, Mac, Solaris(over Ver. 2.6) and the like. Since the true type font has an excellent compatibility between printers and documents so that the same font may be used both in the printer and on the screen, the true type font has prevalently been used in comparison with other contour fonts. Specifically, the true type has a true type font and a true type rasterizer, wherein a true type font file stores a copyright, a font name, licensing permission, technical information on the character, hinting instructions, character group and mapping information in a table format.

Referring to Table 1, there are shown ten true type font tables which are essentially required among maximum 24 tables.

TABLE 1

| Tag | Function |
|---|---|
| Cmap | Table for mapping font information to a corresponding |
| | character |
| Glyph | Font information table |
| Head | General information |
| Hhea | Information on character width |
| Hmtx | Left side bearing and width of each character |
| Loca | Location of each glyph information |
| Maxp | Information on a maximum value required |
| Name | Name of True type |
| Post | Information on postscript |
| OS/2 | Information on Windows and OS/2 |

A Glyph in a font is an image for each character in the font and only one index is assigned to each glyph in the true type. A glyph table is a table for storing an actual character information and has the number of contours for each glyph, coordinate values on the lower left corner and the upper right corner in the x and y coordinates, hinting programs, coordinate points for each glyph and flags for each coordinate point. Accordingly, since the glyph table has all actual information on all glyphs, the glyph table is used to determine the size of the storage space of true type font.

The true type rasterizer is a program for reading font information illustrated on the font table and generating a bitmap and it constitutes a portion of an operation system and software for controlling a printer. In order to generate a character bitmap, the rasterizer reads contour description information for characters from the true type font file and then expands the contour description information for characters in conformity to the required size and the resolution of the device. The hinging information of the rasterizer may be used to adjust the contour and fill the adjusted contour with pixels.

The glyphs in the true type are classified into simple glyphs, each of which is comprised of one or more contour and instructions, and composite glyphs, each of which is comprised of an index for glyphs referred to itself and instructions. The simple glyph is comprised of the coordinate values for font really displayed on the screen. The composite glyph does not have the actual coordinate values but is comprised of an index for glyphs which the composite glyph refers to and a table for determining the scale and location of the composite glyph. Since the composite glyph has a relatively small font data and the shape of the composite glyph depends on that of the corresponding original glyph, the composite glyph causes not to perform burdensome manual operations required during manufacturing a font and, accordingly, is especially useful to manufacture a Korean combination font.

Referring to FIG. 1, there is shown an exemplary view for the structure of a glyph.

An image of the character ‘ [symbol] ’ itself corresponds to the glyph as shown in FIG. 1. Since each closed curve corresponds to a contour in the glyph, closed curves ‘ [symbol] ’ and ‘ [symbol] ’ correspond to contours in FIG. 1. Each point corresponds to a primary coordinate point which is representative of each contour of the character.

Referring to FIG. 2, there are illustrated tables for storing information on a glyph. Each table has an array which can use the glyph number therein as a subscript. Each table stores a font threshold value to xmin, xmax, ymin and ymax, wherein the font threshold value commonly exists in the simple glyph and the composite glyph. A glyph type (Glyftype) stores information on whether the glyph is the simple glyph or the composite glyph. Specifically, if the glyph type (Glyftype) of a glyph is 0, the glyph corresponds to the simple glyph and, if otherwise, the glyph corresponds to the composite glyph. An index of a table corresponding to each glyph is stored as a glyph index (idxglyf). Information on the number of other glyphs which refers to each glyph is stored as a reference number (nReferenced). Referring to FIG. 2, ‘ [symbol] ’ is a simple glyph which has a glyph number of $838 and a minimum and maximum margin of (103, 39) to (552, 755). Accordingly, the glyph type (GlyfType) is 0 and the glyph index (idxglyf) is 205 which may be used to refer to a further detailed information for the simple glyph ‘ [symbol] ’. The number 205 is used as a subscript for referring to information in the simple glyph table. Referring to FIG. 2, ‘ [symbol] ’ is a composite glyph which has a glyph number of $FAF and a minimum and maximum margin of (103, −51) to (940, 785). Accordingly, the glyph type (GlyfType) is 1 and the glyph index (idxglyf) is 17 which may be used as a subscript in the composite glyph to refer to a further detailed information for the composite glyph ‘ [symbol] ’. A table of referenced and another table of arcReferenced are tables for the composite glyph and used to describe the table of nReferenced, wherein the table of nReferenced represents how many other composite glyphs are referred to for each glyph number. Since three composite glyphs ‘ [symbol] [symbol] ’, ‘ [symbol] ’ and ‘ [symbol] ’ refer to ‘ [symbol] ’ as shown in the table of referenced and the table of arcReferenced, the table of nReferenced is set to 3.

In the meantime, Korean fonts may be classified as combination fonts and completion fonts. In each combination Korean font, Korean is divided into an initial consonant, a middle vowel, a final consonant and fonts are separately manufactured for the initial consonant which may be dropped in certain combinations, the middle vowel and the final consonant and the manufactured fonts are combined to generate a font for each character. However, the completion Korean font is a font manufactured in a total shape for each Korean character. In comparison with the completion font, the combination font may be created easily with a less time and effort and a more reduced font storage space while the quality of each character in the combination font is worse than that of the completion font since the characteristic for each element of the initial consonant, the middle vowel and the final consonant must be ignored and only a predetermined portion may be used on the point array. However, the completion font has a better quality of character but requires still more time and efforts and still lager storing volume. In a completion bitmap font, there are 2350 numbers of Korean fonts and 4880 numbers of Chinese fonts. In order to represent the completion bitmap font with a point array of 24 columns and 24 lows, a storage space of 520,560 bytes is required. To store a Unicode with 11,172 numbers of Korean fonts and 20,902 numbers of Chinese fonts, a still larger storage space of 2,309,328 bytes is required. Since a Korean character is generated by combining one or more consonant and a vowel, the same consonant and vowel are required to be repetitively designed to generate a completion Korean font and, therefore, a still larger storage space is required. Accordingly, it is required to minimize the number of redundant consonants and vowels to construct a completion font so that the quality of the completion font may be substantially equal to that of the combination font and time, efforts and storage space required to generate the font may be reduced. In a device, with a memory space considerably limited, such as a cellular phone, an IMT-2000 terminal, a high definition television, a personal digital assistant (PDA), a electronic book or the like, only a minimized font storage space is allowed while the consumer has wanted a more beautiful font, which requires enormous amount of font storage area.

### SUMMARY OF THE INVENTION

It is, therefore, an object of the present invention to provide a method for lossy optimization and storage of font capable of maintaining the quality of the completion Korean font and reducing the storage space and the processing cost. According to the present invention, there is provided a method for lossy optimization and storage of a font, wherein a similarity between unit elements in a font file used for representing characters is used to be capable of minimizing a storage space of the font file, the method comprising the steps of: (a) dividing the font into unit elements on a contour basis to generate a plurality of contours; (b) performing a similarity comparison between the contours to create a similarity comparison list; (c) unifying two or more contours, if the two or more contours are determined to be similar to each other in the similar comparison list; (d) selecting a representative contour to be displayed on a screen among the contours within the similarity comparison list; (e) deleting one or more glyph tables no longer required in the similarity comparison list; and (f) generating a new glyph table by using the glyph tables not deleted at step (e).

### BRIEF DESCRIPTION OF THE DRAWINGS

The above and other objects and features of the present invention will become apparent from the following description of preferred embodiments given in conjunction with the accompanying drawings, in which:

FIG. 1 represents an exemplary view of a glyph structure in a true type font;

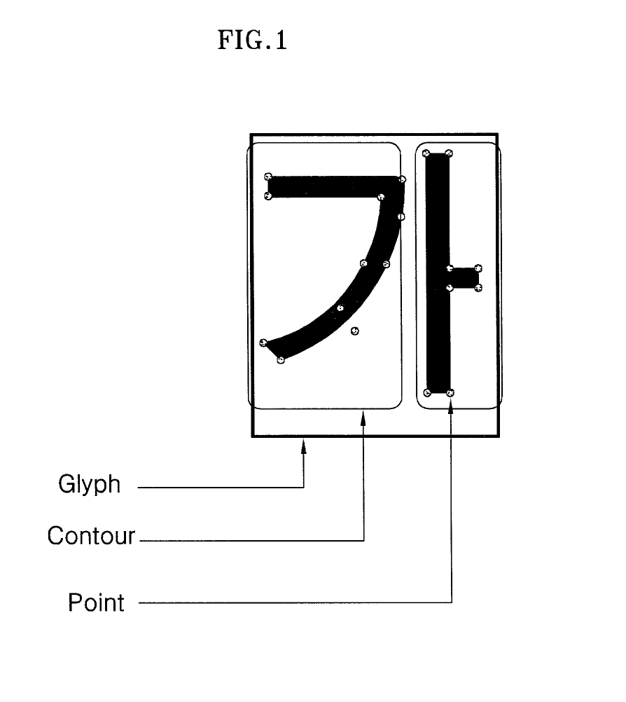

FIG. 2 shows an exemplary view of a table with which information on glyphs may be stored;

FIG. 3 describes a flow diagram for outputting a font in the true type font;

FIG. 4 provides an exemplary view for comparing a similarity between the contours divided in the true type font;

FIG. 5 presents a view of a reconstruction process for a glyph table;

FIG. 6 explains an exemplary view of a first similar type among the similar types shown in FIG. 5;

FIG. 7 illustrates an exemplary view of a second similar type among the similar types shown in FIG. 5;

FIG. 8 describes an exemplary view of a case in which the Cmap table refers to two and more glyphs in the first similar type;

FIG. 9 provides an exemplary view of another case in which one of the simple glyphs which the Cmap table refers to is transformed into a representative glyph in the first similar type;

FIG. 10 is an exemplary view of the case in which, after one of the simple glyphs is transformed into the representative glyph in the first similar type, the reference glyph of ‘ [symbol] ’ is transformed;

FIG. 11 presents an exemplary view of a case in which the Cmap table refers to only one glyph in the first similar type;

FIG. 12 is an exemplary view of the transformation of reference in a case in which the Cmap table refers to only one glyph;

FIG. 13 shows an exemplary view of a case in which the Cmap table has no glyph to be referred to in the first similar type;

FIG. 14 represents an exemplary view of a case in which the Cmap table has no glyph to be referred to in the first similar type and any one glyph is set to be referred to through a transformation process;

FIG. 15 illustrates an exemplary view of a case in which the Cmap table has no glyph to be referred to in the first similar type, any one glyph is set to be referred to and the other glyphs are deleted;

FIG. 16 describes an exemplary view in which there exists a similarity and the glyph table is not transformed yet in the second similar type; and

FIG. 17 provides an exemplary view in which there exists a similarity and the glyph table has been transformed in the second similar type.

### DETAILED DESCRIPTION OF THE PREFERRED EMBODIMENTS

Hereinafter, the present invention will be illustrated by referring to the attached drawings.

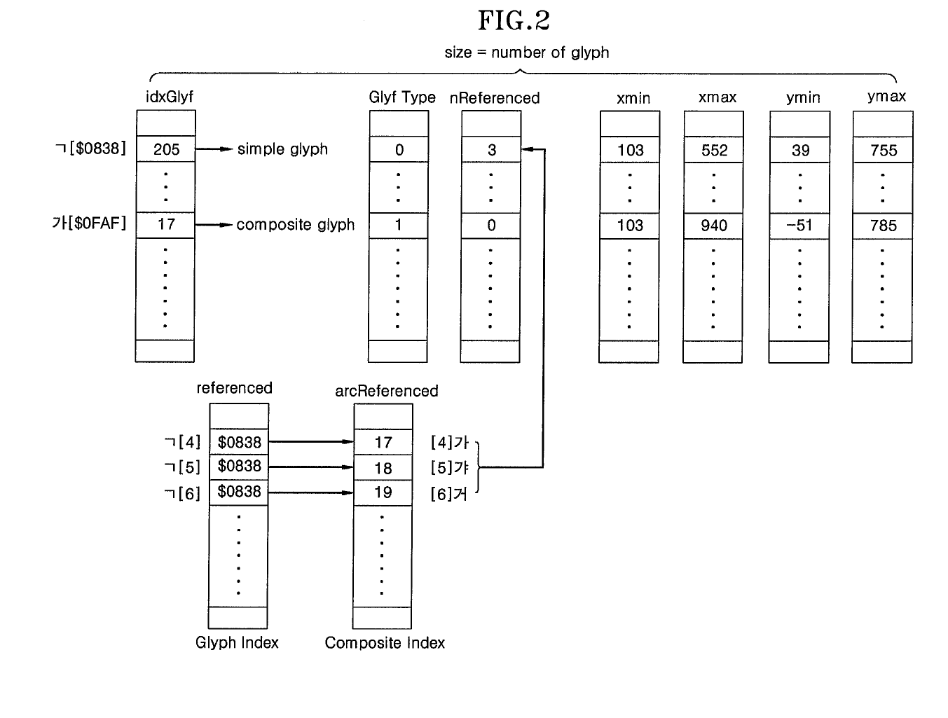

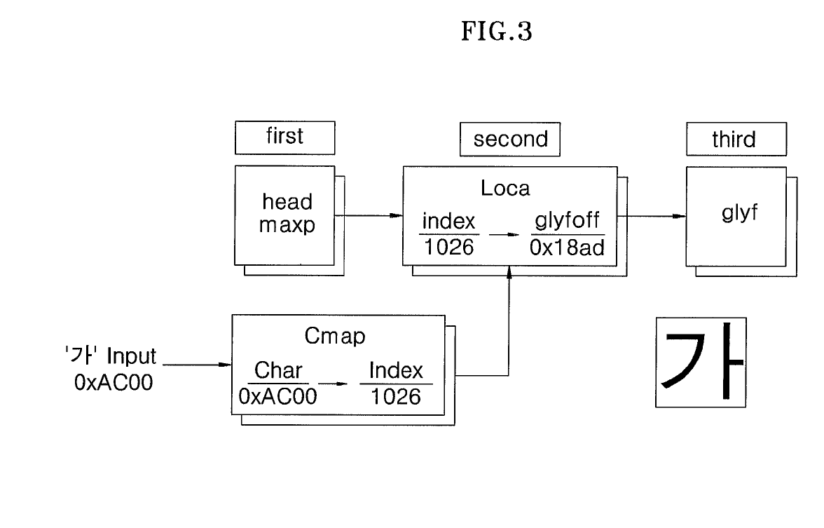

Referring to FIGS. 2 and 3 and Table 1, there will be illustrated a character creation process in accordance with the present invention.

Referring to FIG. 3, there is a flow diagram for representing an exemplary output flow of the true type font for a Korean character ‘ [symbol] ’. In order to make up a font based on a true type font table, if a character code 0xAC00 is given, a glyph index of 1026 depending on the character code 0xAC00 may be obtained from the Cmap table. Information (xmin=103, xmax=940, ymin=−51, ymax=785, glyph type=1, nReferenced=3, idxgylf=17) on a storing format of a Loca table is obtained from a Head table and a total glyph number is obtained from a Maxp table so that the Loca table may be referred to. In the Loca table, location information (0x18ad) on the location of the glyph corresponding to the glyph index may be obtained from the glyph table. From the glyph location obtained from the Loca table, the coordinate values on which the character is represented and other information are obtained so that ‘ [symbol] ’ may be displayed on the screen.

The simple glyph has information on contours which are generated on a closed curve basis and coordinates for drawing a real contour. Although information on the contours and the coordinates for constructing the contours are not separated in the simple glyph, the contours of each glyph are required to be separated in order to effectively perform a similarity comparison. Accordingly, a glyph divided into contours is required to be separately stored as coordinates corresponding to each contour.

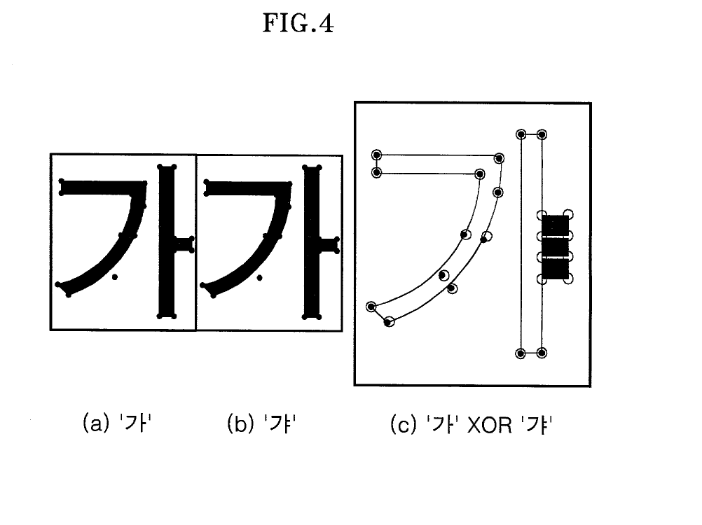

Referring to FIG. 4, there is shown an exemplary view for comparing similarities between contours. By performing an XOR operation between a character ‘ [symbol] ’ and another character ‘ [symbol] ’, it is found a similarity for a common element ‘ [symbol] ’ between two characters. In FIGS. 4A and 4B, the points punctured around the character represent a primary coordinate points for representing the contours of each character. In FIG. 4C, each small circle represents an error range for the primary coordinates to show each contour. The error range is determined by a resolution of the output device and a reference font size. All points within the error range are suggested to correspond to the same coordinate value. Since, for example, all contour coordinates for representing a contour portion ‘ [symbol] ’ and another contour portion ‘ [symbol] ’ commonly contained in both ‘ [symbol] ’ and ‘ [symbol] ’ belong to the error range in FIG. 4, the two contour portions ‘ [symbol] ’ and ‘ [symbol] ’ are determined to be equal in the characters ‘ [symbol] ’ and ‘ [symbol] ’, respectively. Since, however, two contour coordinates for ‘−’ contained in ‘ [symbol] ’ and ‘=’ contained in ‘ [symbol] ’ are departed from the error range, ‘−’ and ‘=’ are determined to be different from each other. If the resolution of the output device and the reference font size are adjusted, the compression ratio of the font may also be adjusted. A similar contour with a similar figure may be treated as relative coordinates for comparing the similarities regardless of the positions of a plurality of contours divided from a character. For example, the location of the initial consonant ‘ [symbol] ’ in ‘ [symbol] ’ is different from that of the final consonant ‘ [symbol] ’ therein but the two consonants are substantially similar to each other from the viewpoint of relative coordinates so that the similar comparison between the two consonants may be required. If the two consonants are watched from absolute coordinates, the location of the initial consonant ‘ [symbol] ’ in ‘ [symbol] ’ is different from that of the final consonant ‘ [symbol] ’ therein so that there is no similarity. In case a similarity comparison list for the contours which are obtained by dividing a character is generated, each of contours, with the similarity comparison lists thereof similar to each other, generally further require one simple glyph to reconstruct a glyph table. Accordingly, since there are many unnecessary lists to further require a plurality simple glyph tables to consume the storage space, the contours may be preferably combined. For example, a basic character ‘ [symbol] ’ has three contours of ‘−’, ‘−’ and ‘o’ while the three contours are not separately used but used at a same time so that three contours may be combined as a single glyph ‘ [symbol] ’ to perform a similarity comparison. After a representative contour for accommodating all the contours slightly different from each other is selected, the contour is transferred into the output device by using a true type rasterizer.

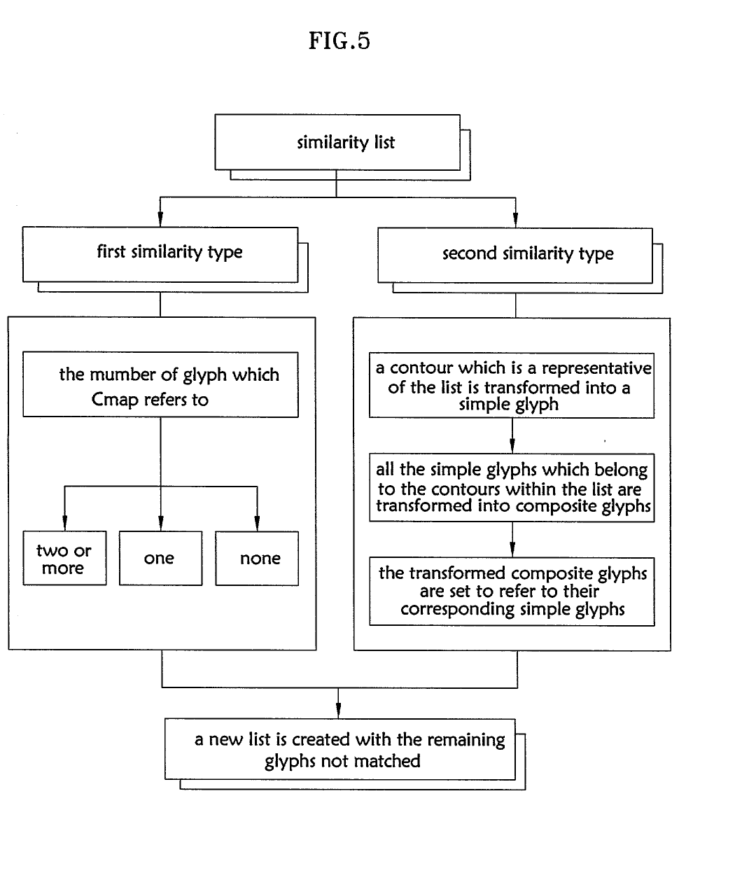

Referring to FIG. 5, there is shown a flow for reconstructing a glyph table. After the divided contours are compared with each other to generate one or more similarity lists, the lists are used to reconstruct a glyph table. First of all, it is checked what is similar in the similarity lists and one or more glyphs which have redundancy are deleted to save the memory. A represent glyph may be generated for each list in order to represent other similar glyphs which may refer to the list.

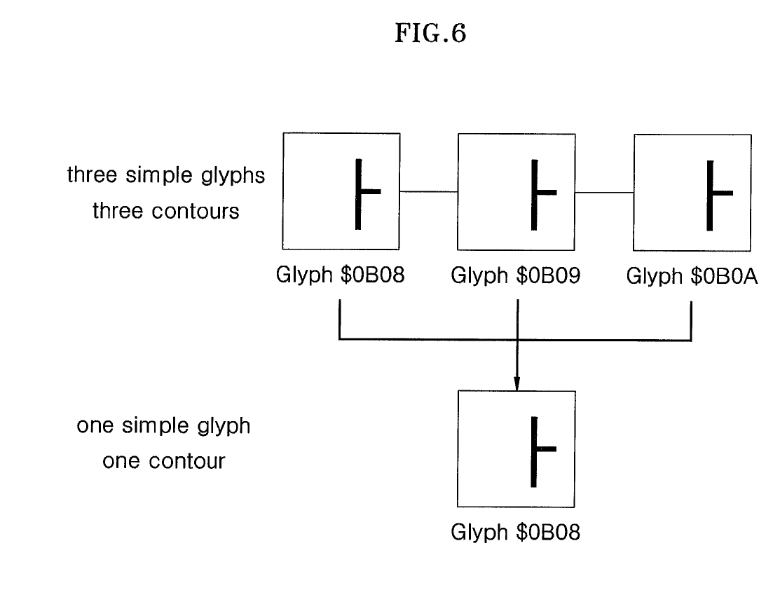

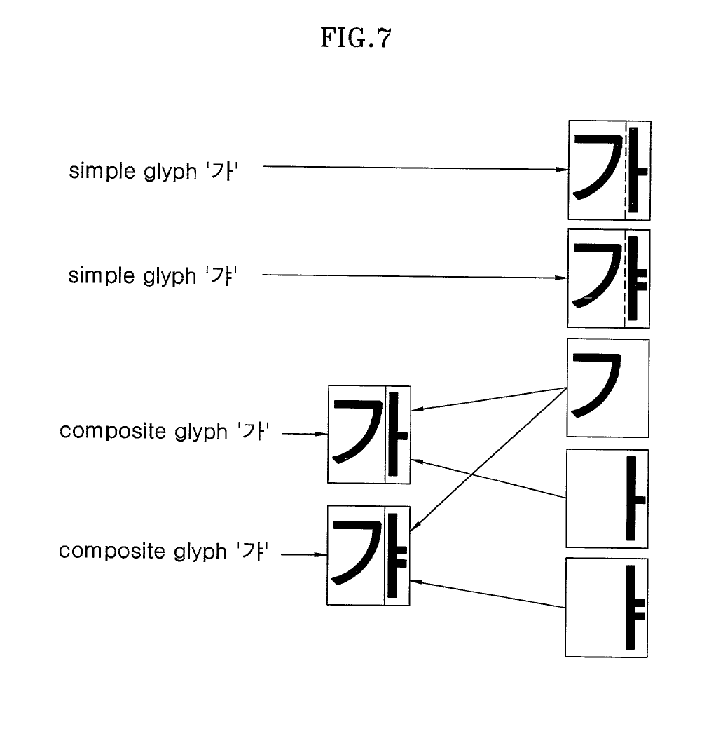

FIGS. 6 and 7 illustrate in detail a method for differentiating a first similar type from a second similar type and deleting an unnecessary glyph table in accordance with the present invention.

Referring first to FIG. 6, there is shown an exemplary view of the first similar type. Specifically, if each simple glyph has a contour as shown in FIG. 6, three similar simple glyphs are correlated with one similarity list. Since there is required no additional contour in this case, one of the 3 simple glyphs is left and the other two simple glyphs are deleted. Specifically, since three simple glyphs ‘ [symbol] ’ (a glyph of $0B08), ‘ [symbol] ’ (a glyph of $0B09) and ‘ [symbol] ’ (a glyph of $0B0A) has only one contour as shown in FIG. 6, only one simple glyph ‘ [symbol] ’ (a glyph of $0B08) is left among the three simple glyphs and the other two glyphs are deleted. If a composite glyph ‘ [symbol] ’ is compared with another composite glyph ‘ [symbol] ’, a similarity comparison test between a contour ‘ [symbol] ’ of the composite glyph ‘ [symbol] ’ and another contour ‘ [symbol] ’ of the composite glyph ‘ [symbol] ’ is required. If the simple glyphs on which the similarity comparison test is required have only one contour or the composite glyphs are compared with each other as shown above, these cases are identified as the first similar type.

Referring to FIG. 7, there is shown an exemplary view of a second similar type. Specifically, since only a contour ‘ [symbol] ’ among two simple glyphs ‘ [symbol] ’ and ‘ [symbol] ’ is related to the similarity list as shown FIG. 7, the simple glyph ‘ [symbol] ’ is determined as a representative glyph for the similarity list for the contour ‘ [symbol] ’ and the remaining parts are separately defined as the simple glyphs ‘ [symbol] ’ and ‘ [symbol] ’. The original simple glyph ‘ [symbol] [symbol] ’ is transformed into a composite glyph ‘ [symbol] [symbol] ’ which refer the simple glyphs ‘ [symbol] ’ and ‘ [symbol] ’. The simple glyph ‘ [symbol] [symbol] ’ is also transformed into a composite glyph ‘ [symbol] [symbol] ’ which refer to the simple glyphs ‘ [symbol] ’ and ‘ [symbol] ’. If the simple glyphs on which the similarity comparison test is required have two or more contours as shown above and the similarity comparison test on only some contours is required, this case is identified as the second similar type. Accordingly, two simple glyphs ‘ [symbol] ’ and ‘ [symbol] ’ having two contours are transformed into three simple glyphs ‘ [symbol] ’, ‘ [symbol] ’ and ‘ [symbol] ’ having only one contour and two composite glyphs ‘ [symbol] ’ and ‘ [symbol] ’. In this case, the total number of glyph tables increases from 2 to 5 but 4 contours ‘ [symbol] ’, ‘ [symbol] ’, ‘ [symbol] ’ and ‘ [symbol] ’ may be replaced with 3 contours ‘ [symbol] ’, ‘ [symbol] ’ and ‘ [symbol] ’. Accordingly, since the number of points may be considerably decreased, the storage capacity required for the font data may be decreased.

After the unnecessary glyph tables are eliminated as described above, a new glyph table may be generated according to the similar type thereof.

In the first similar type, it is checked how many glyphs in one list are referred to by the Cmap. Specifically, whether the number of glyphs referred to by the Cmap is 2 and more, 1 or none, determines a flow for generating the new glyph table. In the second similar type, a contour representing the list is set to be a simple glyph as a representative glyph and then the simple glyphs for all the contours in the list are transformed into composite glyphs, respectively. The transformed composite glyphs refer to the representative glyph of the similarity list which has the contours in the simple glyphs while each of the contours which have no similarity list generates another new glyph to be referred to.

First of all, there is illustrated the first similar type shown in FIG. 5.

1) First Case.

If the Cmap refers to two or more glyphs, one of the two or more glyphs is set to be a representative glyph and the other glyphs are transformed into composite glyphs which refer to the representative glyph. If there exists another composite glyph referring to each of the glyphs within the similarity comparison list, the references of the composite glyphs are transformed into the representative glyph and all the other glyphs which do not refer to the Cmap are deleted.

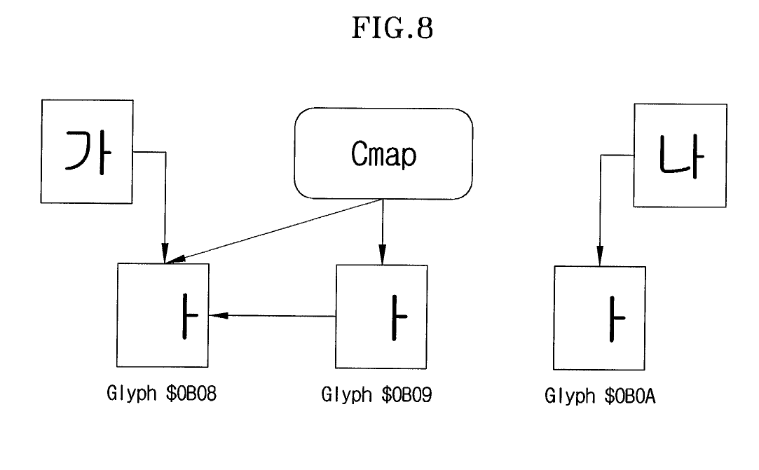

Referring to FIGS. 8 to 10, there is an exemplary view of a Cmap table which refers to two or more glyphs. Referring to FIG. 8, two composite glyphs ‘ [symbol] ’ and ‘ [symbol] ’ and the Cmap table refer to three different glyphs, respectively. In this case, one glyph among the two glyphs referred to the Cmap table is set to be a representative glyph, the other glyph among the two glyphs referred to the Cmap table is transformed into a composite glyph which refers to the representative glyph and the two composite glyphs ‘ [symbol] ’ and ‘ [symbol] ’ are set to refer to the representative glyph. Then, one glyph which is not referred to is deleted. Referring to FIG. 8, the composite glyph ‘ [symbol] ’ refers to a glyph $0B08, the Cmap table refers to two glyphs $0B08 and $0B09 and the composite glyph ‘ [symbol] ’ refers to a glyph $0B0A. One glyph $0B08 among the two glyphs referred to the Cmap table is set to be a representative glyph and the other glyph $0B09 is transformed into a composite glyph which refers to the representative glyph. After two composite glyphs ‘ [symbol] ’ and ‘ [symbol] ’ are also set to refer to the representative glyph $0B08, the glyph $0B0A which is not referred to must be deleted.

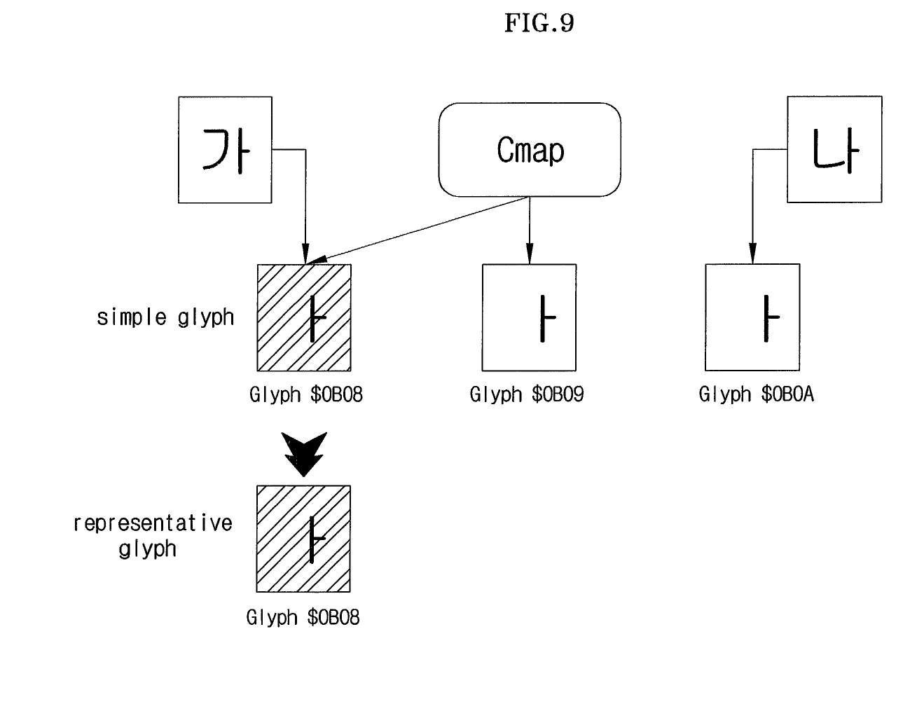

Referring to FIG. 9, there is shown an exemplary view in which one of simple glyphs which the Cmap table refers to is transformed into a representative glyph.

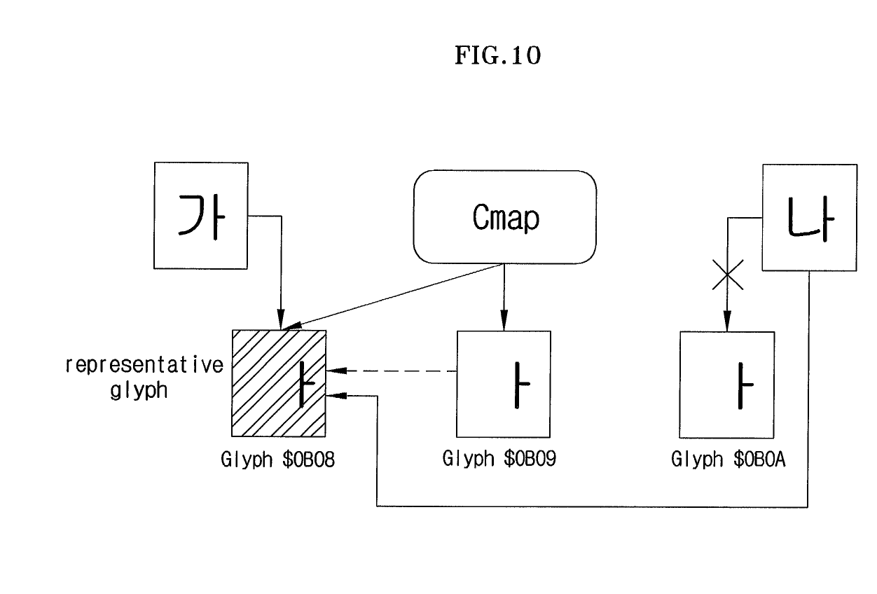

Referring to FIG. 10, there is shown an exemplary view of the reference glyph transformation of the composite glyph ‘ [symbol] ’ after the simple glyph is transformed into a representative glyph.

2) Second Case.

If the Cmap table refers to only one glyph, the glyph is set to be a representative glyph and then all the composite glyphs which have referred to other glyphs are set to refer to the representative glyph. At last, all the other glyphs except the representative glyph are deleted.

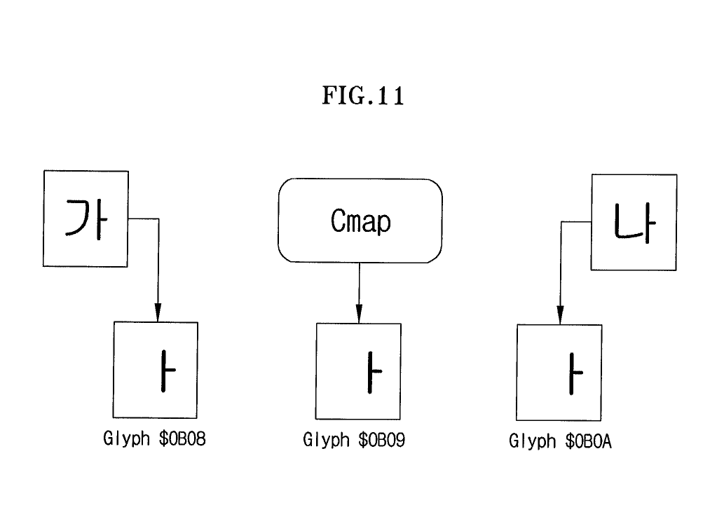

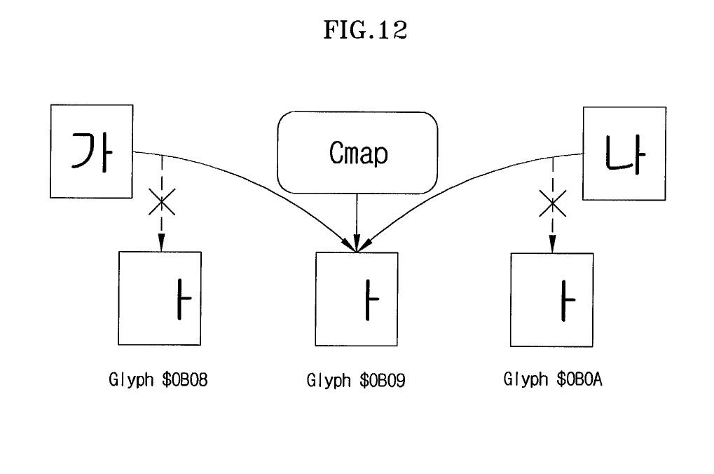

Referring to FIGS. 11 and 12, there is shown an exemplary view in which the Cmap table refers to only one glyph. The Cmap shown in FIG. 11 refers to one glyph $0B09. In this case, the glyph $0B09 is set to be the representative glyph and the composite glyphs ‘ [symbol] ’ and ‘ [symbol] ’ which refer to glyphs $0B08 and $0B0A, respectively, are set to refer to the representative glyph $0B09 as shown in FIG. 12. The other glyphs $0B08 and $0B0A are deleted.

Referring to FIG. 12, there is shown an exemplary view of a reference transformation in which the Cmap table refers to only one glyph.

3) Third Case.

If there is no glyph to which the Cmap table refers, any one glyph is set to be a representative glyph and the composite glyphs which have referred to the other glyphs is set to refer to the representative glyph. The other glyphs are eliminated.

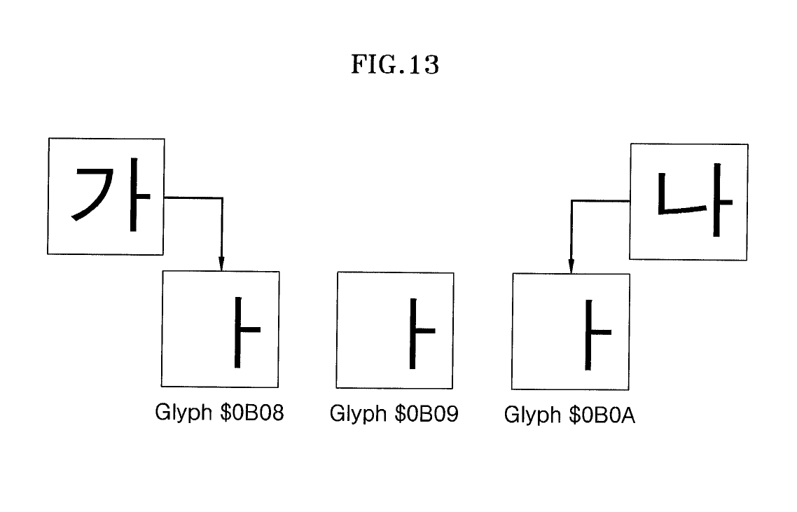

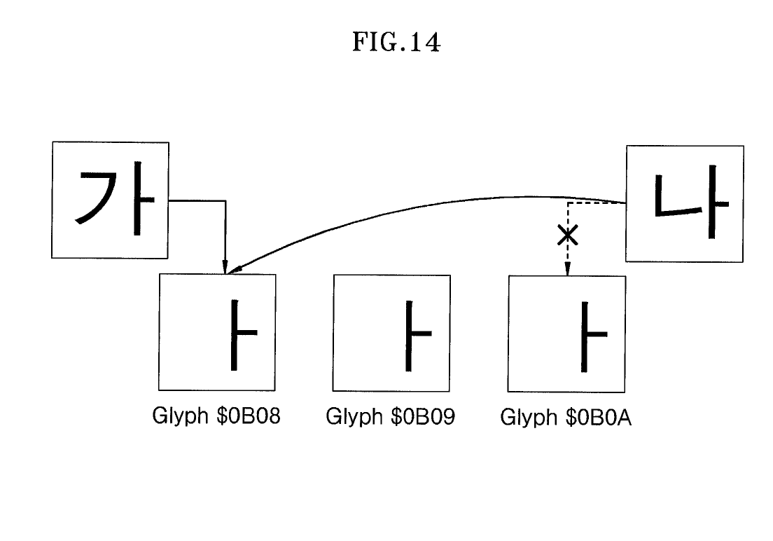

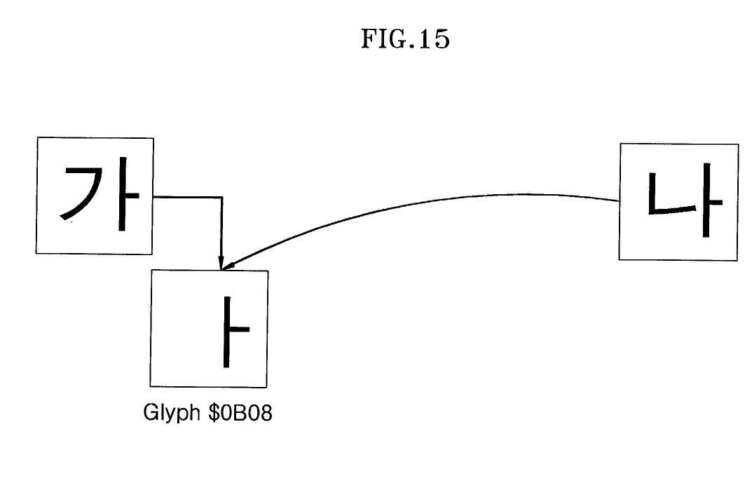

Referring to FIGS. 13 to 15, there is shown an exemplary view in which the Cmap table has no glyph to be referred to. Referring to FIG. 13, a composite glyph ‘ [symbol] ’ refers to a glyph $0B08 and another composite glyph ‘ [symbol] ’ refers to a glyph $0B0A. The glyph $0B08 is set to a representative glyph, the composite glyph ‘ [symbol] ’ is set to refer to the representative glyph $0B08 as shown in FIG. 14 and then the glyphs $0B09 and $0B0A are deleted as shown in FIG. 15.

Referring to FIG. 14, there is shown an exemplary view in which the Cmap table has no glyph to be referred to and any one glyph is set to be referred to as a representative glyph.

Referring to FIG. 15, there is shown an exemplary view in which the Cmap table has no glyph to be referred to, any one glyph is set to be referred to as a representative glyph and the other glyphs are deleted.

From now, there will be illustrated the second similar type shown in FIG. 5.

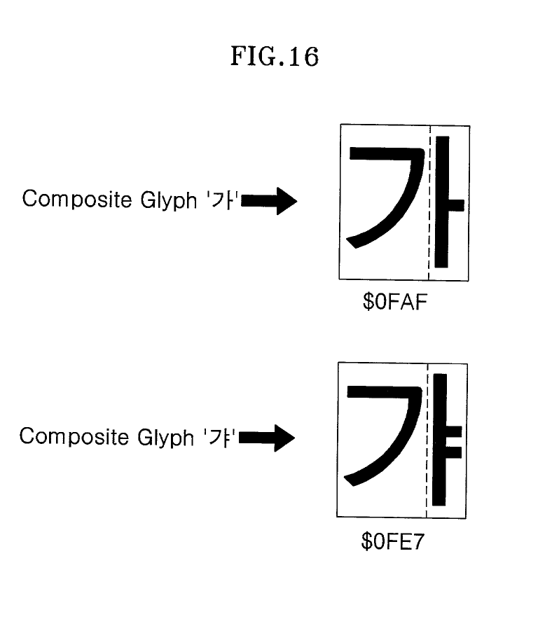

Referring to FIG. 16, there is shown an exemplary view in which there exists a similarity and the glyph table is not transformed yet in the second similar type. The simple glyph ‘ [symbol] ’ is $0FAF and the simple glyph ‘ [symbol] ’ is $0FE7 as shown in FIG. 16.

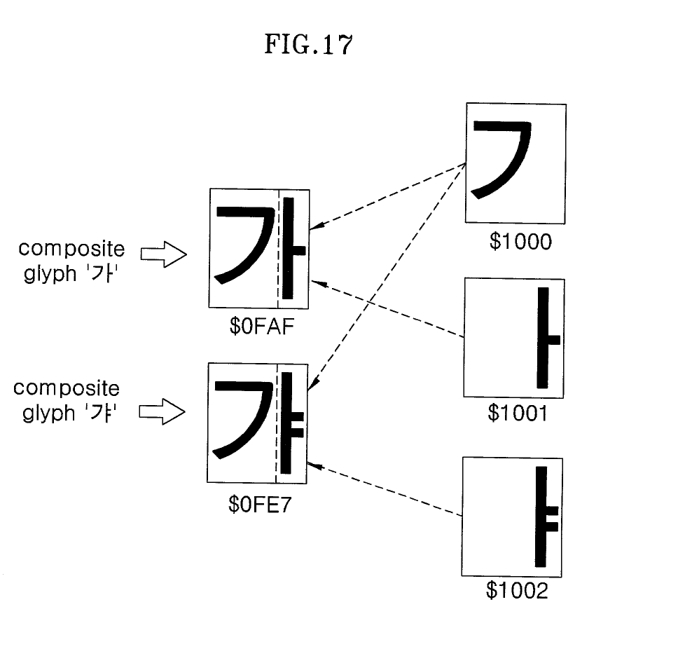

Referring to FIG. 17, there is shown an exemplary view in which there exists a similarity and the glyph table has been transformed in the second similar type. As shown in FIG. 17, a simple glyph ‘ [symbol] ’ is generated at $1000 to represent a similarity list of a contour ‘ [symbol] ’ and two simple glyphs $0FAF and $0FE7 are transformed into composite glyphs. The simple glyph ‘ [symbol] ’, i.e., $0FAF, is transformed into a composite glyph which refers to the simple glyph ‘ [symbol] ’, i.e., $1000, and a simple glyph $1001 which is newly generated from the remaining contour ‘ [symbol] ’. The simple glyph ‘ [symbol] ’, i.e., $0FE7, is transformed into a composite glyph which refers to the simple glyph ‘ [symbol] ’, i.e., $1000, and a simple glyph $1002 which is newly generated from the remaining contour ‘ [symbol] ’. Based on a new glyph table newly generated through this process, a LOCA table and a POST table may be transformed. Each maximum value recorded on Maxp may also be transformed and the format of the LOCA table within the Head may be redefined. At last, all the remaining tables are assembled to generate a true type table.

In accordance with the present invention, each glyph is divided on a contour basis in the Korean true type font file to generate lossy optimization and the glyph table is reconstructed by using the similarity between contours. As a result, a new glyph table is generated to save the storage space of the Korean true type font.

In the meantime, each character of Chinese characters consists of a plurality of contours in a character as those of Korean characters are. Since a number of Chinese characters are made up by combining common elements, the common elements may be set to be a representative glyph with a considerable effect according to the method described above. For example, in order to represent Chinese characters [symbol] and [symbol] , a contour of a common element therein ‘ [symbol] ’ may be used to reconstruct a old glyph table as a new glyph table and, therefore, a lossy optimization of the font data may be achieved, and, therefore, the storage space thereof may be reduced. The above method may be applied to the symbols such as the umlaut, i.e., , in German characters and the accent aigu, i.e., , accent grave, i.e., , the accent circonflexe, i.e., and the trema, i.e., ″, in French characters. The method may be applied to Japanese characters such as ‘ [symbol] ’, ‘ [symbol] ’ and ‘ [symbol] ’ which have a similar contour. In the meantime, the above method will be applied to similar characters in Vietnamese, Indian, Thai, Arabian, English, German, French, Spanish or the like.

Although the unit elements are stored as the completion type in the font file for representing the characters, the process of similarity comparison, the representative contour extraction and the reconstruction of the glyph table may be used to generate a combination type font which has a fixed combination rule corresponding to the combination type font. Accordingly, some Korean characters which cannot be expressed due to the limitation of the storage in case using the completion font can be generated by the inventive method with only limited storage.

As described above, the quality of the original font is maintained without modifying the processing program through the lossy optimization of Korean font in accordance with the present invention. 11,172 numbers of Unicode Korean characters may be used in a lower resolution output device or in a device with a limited storage space such as a cellular phone, an IMT-2000 terminal, a high definition television (HDTV), a personal digital assistant (PDA), a electronic book or the like in accordance with the present invention. Since the character font is saved based on the reference information of glyph, neither parameter determination nor program modification may be required in the combination font. A new Korean font may be developed with a reduced manufacturing time and cost in accordance with the present invention.

While the invention has been shown and described with respect to the preferred embodiments, it will be understood by those skilled in the art that various changes and modifications may be made without departing from the spirit and scope of the invention as defined in the following claims.

What is claimed is:

1. A method for lossy optimization and storage of a font, wherein a similarity between unit elements in a font file used for representing characters is used to be capable of minimizing a storage space of the font file, the method comprising the steps of:
(a) dividing the font into unit elements on a contour basis to generate a plurality of contours;
(b) performing a similarity comparison between the contours to create a similarity comparison list;
(c) unifying two or more contours, if the two or more contours are determined to be similar to each other in the similar comparison list;
(d) selecting a representative contour to be displayed on a screen among the contours within the similarity comparison list;
(e) deleting one or more glyph tables no longer required in the similarity comparison list; and
(f) generating a new glyph table by using the glyph tables not deleted at step (e).

2. The method of claim 1, wherein, at step (a), information on the contours and the contours themselves are separately stored on a coordinate basis.

3. The method of claim 2, wherein, at step (b), an XOR operation between two contours in a relative coordinate system is performed without considering absolute coordinate values of the contours in an absolute coordinate system and, if all points through the XOR operation belong to an error range, the two contour is determined to be similar to each other.

4. The method of claim 3, wherein the size of the error ranges is determined by a resolution of an output device and a default font size.

5. The method of claim 4, wherein a font compression ratio is adjusted by controlling the resolution of the output device and the default font.

6. The method of claim 1, wherein, at step (c), contours which are not used separately but always used together, are merged as one unit element.

7. The method of claim 1, wherein, at steps (d), (e) and (f), in case of a first similar type, a representative simple glyph among a plurality of similar simple glyphs is chosen or made; the other simple glyphs except the representative glyph are deleted; the other glyphs are transformed into composite glyphs which refers to the representative glyph; if there exist one or more composite glyphs which refer to the glyphs in the similarity comparison list, the composite glyphs are set to refer to the representative glyph; and the glyphs which do not refer to a table mapped into a character corresponding to font information are deleted to generate the new glyph table.

8. The method of claim 1, wherein, at steps (d), (e) and (f), in case of a second similar type, a contour is transformed into a simple glyph to be a representative glyph for representing the similarity comparison list, wherein the contour is one of the contours correlated as the similar comparison list because of the similar figures of the contours of the simple glyphs; the contours having no similarity comparison list are set to be new simple glyphs; the simple glyphs corresponding to the contours in the similarity comparison list are transformed into composite glyphs which refer to the representative glyph and the new simple glyphs; and the other glyphs except the representative glyph in the similarity comparison list are deleted to generate the new glyph table.

9. The method of claim 1, the fonts for representing characters such as Korean, Chinese, Japanese, Vietnamese, Indian, Thai, Arabian, English, German, French, Spanish are a character set which is represented as the contours and is divided as the unit elements.

10. The method of claim 1, wherein the unit elements stored by a completion code in the font file are stored as a combination code which has a fixed combination rule through a similarity comparison, a representative contour extraction and a reconstruction of glyph table and one or more characters omitted in the completion code are created as the combination code to be stored.
